(19) United States
(12) Patent Application Publication
(10) Pub. No.: US 2019/0354851 A1
(43) Pub. Date: Nov. 21, 2019

(54) CONSTRUCTION OF A MACHINE LEARNING MODEL FOR STRUCTURED INPUTS

(71) Applicant: INTERNATIONAL BUSINESS MACHINES CORPORATION, Armonk, NY (US)

(72) Inventors: Zehra N. SURA, Yorktown Heights, NY (US); Tong CHEN, Yorktown Heights, NY (US); Hyojin SUNG, Ossining, NY (US)

(73) Assignee: INTERNATIONAL BUSINESS MACHINES CORPORATION, Armonk, NY (US)

(21) Appl. No.: 15/982,688

(22) Filed: May 17, 2018

(51) Int. Cl. G06N 3/08; G06N 3/04

(52) U.S. Cl. CPC G06N 3/08; G06F 17/211; G06N 3/0427

(57) ABSTRACT

Embodiments for construction of a machine learning model for structured inputs by a processor. A domain knowledge may be applied to identify the one or more grammar entities. Input data may be arranged into one or more grammar entities identified using the domain knowledge. Each of the one or more grammar entities may be modularly adapted to one or more grammar entity functions to create a machine learning model. One or more rules may be used to create each of the one or more grammar entity functions.

### BACKGROUND OF THE INVENTION

### Field of the Invention

The present invention relates in general to computing systems, and more particularly to, various embodiments for construction of a machine learning model for structured inputs by a processor.

### Description of the Related Art

In today's society, consumers, business persons, educators, and others communicate over a wide variety of mediums in real time, across great distances, and many times without boundaries or borders. With the increased usage of computing networks, such as the Internet, humans are currently inundated and overwhelmed with the amount of information available to them from various structured and unstructured sources. Due to the recent advancement of information technology and the growing popularity of the Internet, a wide variety of computer systems have been used in machine learning. Machine learning is a form of artificial intelligence that is employed to allow computers to evolve behaviors based on empirical data.

### SUMMARY OF THE INVENTION

Various embodiments for construction of a machine learning model for structured inputs by a processor, are provided. In one embodiment, by way of example only, a method for modularly constructing a neural network for deep learning problems, again by a processor, is provided. A domain knowledge may be applied to identify the one or more grammar entities. Input data may be arranged into one or more grammar entities identified using the domain knowledge. Each of the one or more grammar entities may be modularly adapted to one or more grammar entity functions to create a machine learning model. One or more rules may be used to create each of the one or more grammar entity functions.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block diagram depicting various user hardware and computing components functioning in accordance with aspects of the present invention;

FIG. 5A-5D are additional diagrams depicting a structure of a machine learning model for an input data instance in accordance with aspects of the present invention;

FIG. 6 is a flowchart diagram depicting an additional exemplary method for construction of a machine learning model for structured inputs, again in which various aspects of the present invention may be realized; and

FIG. 7 is an additional flowchart diagram depicting an additional exemplary method for construction of a machine learning model for structured inputs, again in which various aspects of the present invention may be realized.

### DETAILED DESCRIPTION OF THE DRAWINGS

Machine learning allows for an automated processing system (a “machine”), such as a computer system or specialized processing circuit, to develop generalizations about particular data sets and use the generalizations to solve associated problems by, for example, classifying new data. Once a machine learns generalizations from (or is trained using) known properties from the input or training data, it can apply the generalizations to future data to predict unknown properties.

In machine learning and cognitive science, neural networks are a family of statistical learning models inspired by the biological neural networks of animals, and in particular the brain. Neural networks can be used to estimate or approximate systems and functions that depend on a large number of inputs and are generally unknown. Neural networks use a class of algorithms based on a concept of inter-connected “neurons.” In a typical neural network, neurons have a given activation function that operates on the inputs. By determining proper connection weights (a process also referred to as “training”), a neural network achieves efficient recognition of desired patterns, such as images and characters. Oftentimes, these neurons are grouped into “layers” in order to make connections between groups more obvious and to each computation of values. Training the neural network is a computationally intense process. For example, designing machine learning (ML) models, particularly neural networks for deep learning, is a trial-and-error process, and typically the machine learning model is a black box.

Currently, these techniques all require the ML model (e.g. neural network) to learn the structure in input data, which can make learning more difficult. For example, the current techniques using neural networks that consider structure include: 1) natural language process that may introspect the network after training to correlate high-level semantics to individual components of the network, 2) ResNets and/or DenseNets that may structure networks such that individual layers have access to different permutations and/or combinations of the input data; 3) attention networks that may allow some layers of the neural network structure to focus on a part of the input data; and/or 4) neural machine translation that may use an encoder-decoder neural network model where the encoder output exposes the structure in the input data and the model learns how to do this.

Given the limitations of learning a structure of the input data, a need exists for constructing a machine learning model that is based on the grammar of input data. In one aspect, the present invention provides for constructing the machine learning model based on the grammar/structure of input data and implicitly carries over the grammar/structure of input data into a structure of the machine learning model. The machine learning model may modularly adapts to the structure of each individual grammar/structure of input data.

In one aspect, the present invention provides for constructing one or more machine learning models that uses and incorporates a structure of the input data (e.g., structured input data) as part of the machine learning model. That is, the present invention provides for designing a machine learning model to learn a selected function F(x), where F is a function and where X belongs to grammatically structured input domain. A domain knowledge may be applied to find grammar entities that are relevant to a learning problem. Input data may be formatted in a selected arrangement of grammar entities. The grammar entities may be annotated with selected property information (e.g., added property data). Each grammar entity may be statically mapped to a function. The function (e.g., a grammar entity function “GEFN” may be: 1) a function that is known apriori, and/or 2) an unknown function to be learned (e.g. by using a corresponding neural network that learns the function. One or more rules based on the input data format may be used that define how to compose functions associated with each of the grammar entities in an input data item.

In an additional aspect, the present invention provides for construction of a modular machine learning (“ML”) model whose structure is dependent on a structure of the input. The modular ML model may be composed of one or more smaller components called grammar entity functions or “GE-FNs”, each of which is associated with a grammar entity (e.g., grammar token, expression, or subset of tokens/expressions). The number and size of GE-FNs can be varied according to problem requirements and domain knowledge (for deep learning). GE-FNs can be functions that are known apriori, or functions that are to be learned. The composition of the overall ML model follows rules that are based on the format of the input data (which can be a sequence, stack-based, tree-based, or graph-based). The GE-FNs for functions to be learned can be individually trained using a targeted training input data set. The overall ML model structure is traversed specific to each input data item, but the components used in the ML model are trained across the input set.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

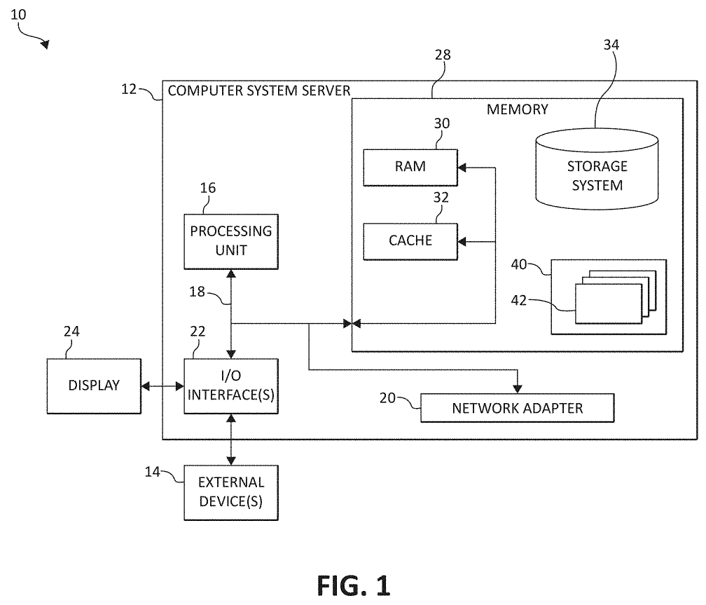

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

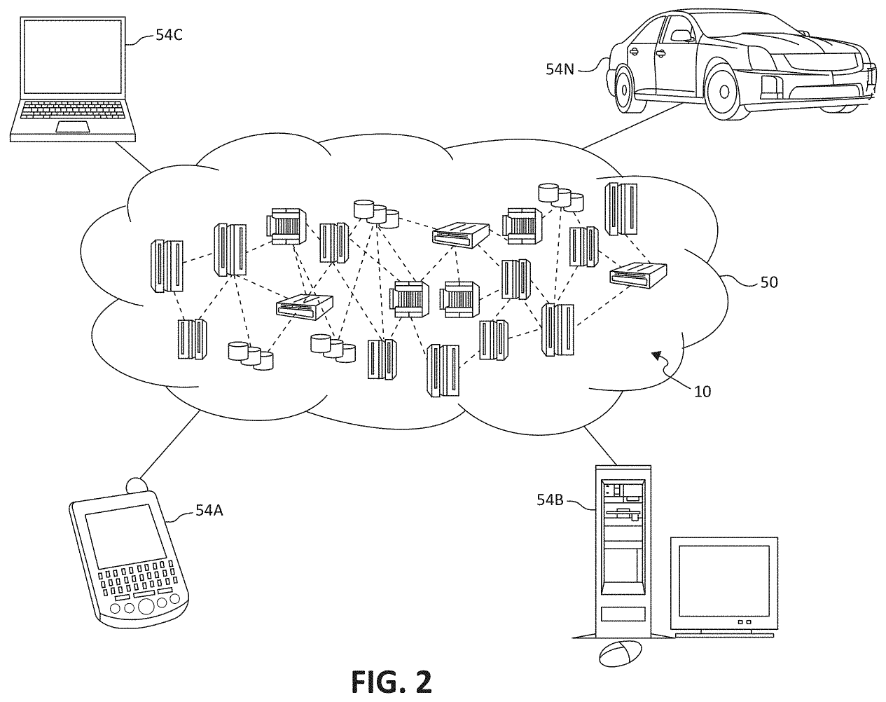

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

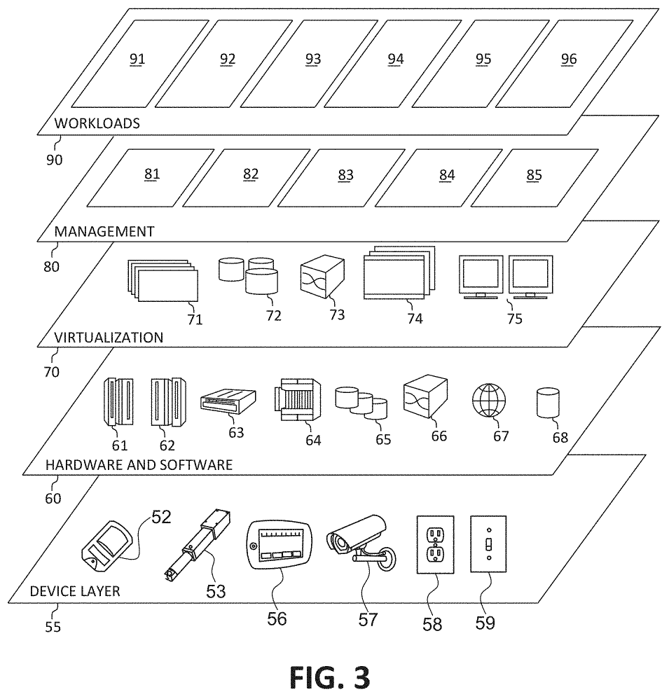

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for construction of a machine learning model for structured inputs. In addition, workloads and functions 96 for construction of a machine learning model for structured inputs may include such operations as data analytics, data analysis, and as will be further described, notification functionality. One of ordinary skill in the art will appreciate that the workloads and functions 96 for construction of a machine learning model for structured inputs may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the present invention provides for modularly constructing a neural network for deep learning problems. All data items input into the deep neural network may be defined by semantics or “grammar” (e.g., individual tokens and expressions, or subsets of tokens/expressions). In one aspect, input data items may be arranged in multiple grammar entities format such as sequence, tree, graph etc. The structure of the input data may be implicitly carried over into a structure of a machine learning model. The structure of the input data in each individual input data item may be modularly synthesized, adapted, or mapped by utilizing one or more grammar entity neural network (“GE-NN) (e.g., GE functions) as components that are interconnected by rules that are specific to the input data format. That is, each GE-NN are individual and differential components that form a total or final machine learning model.

That is, the present invention provides for automatically preprocessing of semantic entities to build a statistical grammar model by tagging part-of-speech, named entity chunking, thereby reducing a level of supervision of training data. The present invention provides for modularly constructing a neural network for deep learning problems, wherein all input data items to the deep neural network are defined by grammar. In this way, training data may be transformed based on frequency of occurrence of each concept corresponding to one or more categories to improve data classification thereby enabling an improved and more efficient training data set.

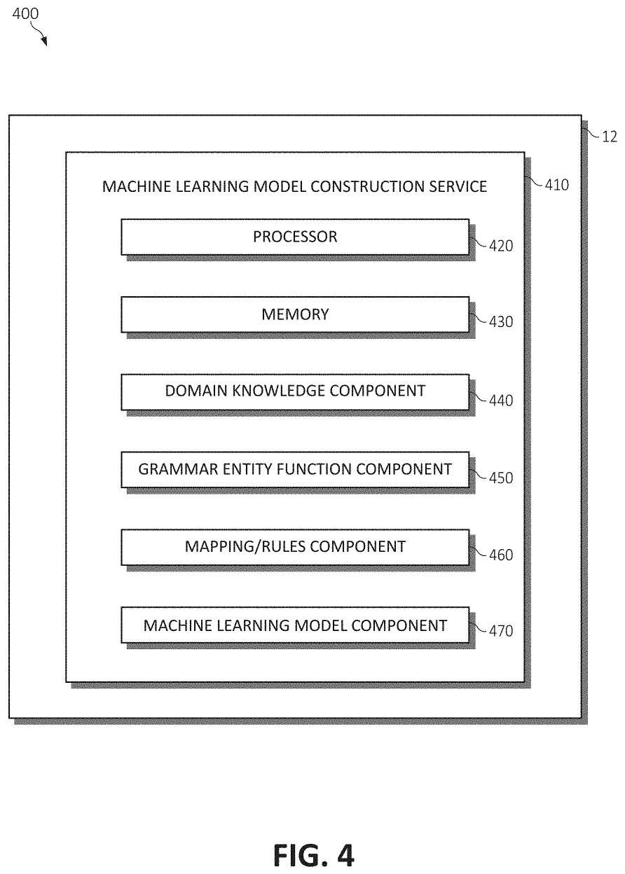

Turning now to FIG. 4, a block diagram depicting exemplary functional components 400 according to various mechanisms of the illustrated embodiments is shown. In one aspect, one or more of the components, modules, services, applications, and/or functions described in FIGS. 1-3 may be used in FIG. 4. A machine learning model construction service 410 is shown, incorporating processing unit (“processor”) 420 to perform various computational, data processing and other functionality in accordance with various aspects of the present invention. The machine learning model construction service 410 may be provided by the computer system/server 12 of FIG. 1. The processing unit 420 may be in communication with memory 430. The machine learning model construction service 410 may include a domain knowledge component 440, a grammar entity function component 450, a mapping/rules component 460, and a machine learning model component 470.

As one of ordinary skill in the art will appreciate, the depiction of the various functional units in machine learning model construction service 410 is for purposes of illustration, as the functional units may be located within the machine learning model construction service 410 or elsewhere within and/or between distributed computing components.

In one embodiment, by way of example only, the machine learning model construction service 410 may modularly construct a neural network for deep learning problem. A domain knowledge may be applied via the domain knowledge component 440 to identify the one or more grammar entities of input data. The one or more grammar entities may be derived from the underlying input domain grammar. The grammar entities of input data may be individual tokens or expressions, or subsets of tokens and expressions. For example, assume a learning problem is estimating the dynamic instruction count of a computer program with basic blocks and loops. The input domain grammar may be grammar for computer programs in a selected programming language. The relevant grammar entities of the input domain grammar may be basic block (BB), loop start token (LSTART), loop end token (LEND).

Input data may be formatted in a selected arrangement of grammar entities. Each grammar entity may be annotated with additional or extra property information. For example, the selected arrangement of grammar entities may be a simple sequence, a stack-based format, a tree ordering, and/or a graph-based format. Continuing with the above example, a simple sequence format may be used, for example, for the grammar entities. Thus, the BB grammar entities may be annotated with an instruction count (e.g., 5, 10, and 15). The LSTART and LEND may be annotated with a loop iteration count (e.g., “20”). Thus, an example input string may be: “BB 10 LSTART 20 BB 5 LEND 20 BB 15”.

The mapping/rules component 460 may statically map each grammar entity to a function. The function may be referred to as a grammar entity function (“GE-FN”). The grammar entity function may be: 1) a function that is known apriori; 2) an unknown function to be learned (e.g. by using a corresponding neural network that learns the function). Each grammar entity function may receive or take two inputs: 1) the current state vector, and 2) an annotated property input value (e.g., annotated property data). Each grammar entity function may produce one output: 1) a next state vector. In one aspect, the mapping/rules component 460 may provide flexible mappings from the grammar entities to one or more functions such as, for example, 1-to-1, or many-to-1 mapping. Continuing with the above example: the BB grammar entities may be mapped to a first function (“F1”), the LSTART grammar entity may be mapped to a second function (“F2”), and the LEND grammar entity may be mapped to a third function (“F3”). Moreover, in one aspect, F1, F2, and F3 may be unknown and to be learned by the individual neural networks of F1, F2, and F3. The neural networks corresponding to F1, F2, and F3 may be smaller networks that are components of the final neural network for learning the overall function F(x).

Thus, input data may be arranged via the mapping/rules component 460 into one or more grammar entities identified using the domain knowledge of the domain knowledge component 440. The grammar entity function component 450 and the machine learning model component 470 may work in association with each other so that each of the one or more grammar entities may be modularly adapted (e.g., mapped) to one or more grammar entity functions to create a machine learning model.

The mapping/rules component 460 may use one or more rules to create each of the one or more grammar entity functions, which may be used and/or stored in the grammar entity function component. That is, the mapping/rules component 460 may use rules based on the input data format that define how to compose functions associated with each of the grammar entities in an input data item. Continuing with the above example where the format is a simple sequence, the output of a preceding function may be the input state vector of succeeding function. For the example, the input data “X” may be “BB 10 LSTART 20 BB 5 LEND 20 BB 15” and the output may be: F(x)=F1(F3(F1(F2(F1(initial, 10), 20), 5), 20), 15), where “initial” may be a preset initial value for the state vector.

By way of example only, the machine learning component 470 may determine one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural networks, Bayesian statistics, naive Bayes classifier, Bayesian network, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

In one aspect, the domain knowledge of the domain knowledge component 440 may be an ontology of concepts representing a domain of knowledge. A thesaurus or ontology may be used as the domain knowledge and may also be used to identify semantic relationships between observed and/or unobserved variables. In one aspect, the term “domain” is a term intended to have its ordinary meaning. In addition, the term “domain” may include an area of expertise for a system or a collection of material, information, content and/or other resources related to a particular subject or subjects. A domain can refer to information related to any particular subject matter or a combination of selected subjects.

The term ontology is also a term intended to have its ordinary meaning. In one aspect, the term ontology in its broadest sense may include anything that can be modeled as an ontology, including but not limited to, taxonomies, thesauri, vocabularies, and the like. For example, an ontology may include information or content relevant to a domain of interest or content of a particular class or concept. The ontology can be continuously updated with the information synchronized with the sources, adding information from the sources to the ontology as models, attributes of models, or associations between models within the ontology.

Additionally, the domain knowledge component 440 may include a domain of knowledge and/or include one or more external resources such as, for example, links to one or more Internet domains, webpages, and the like.

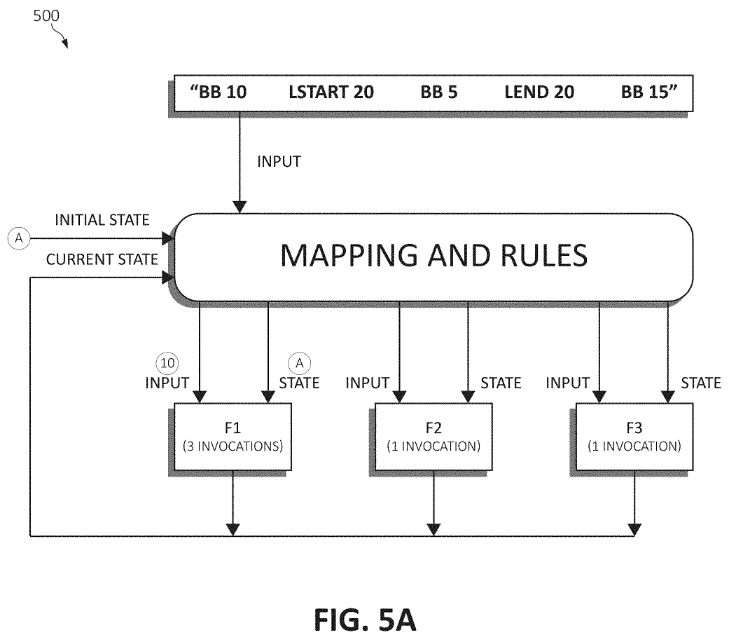

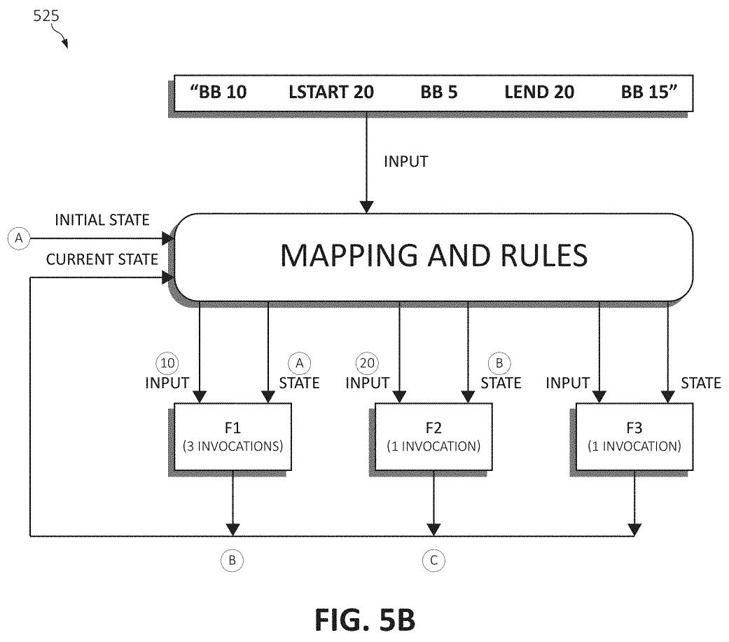

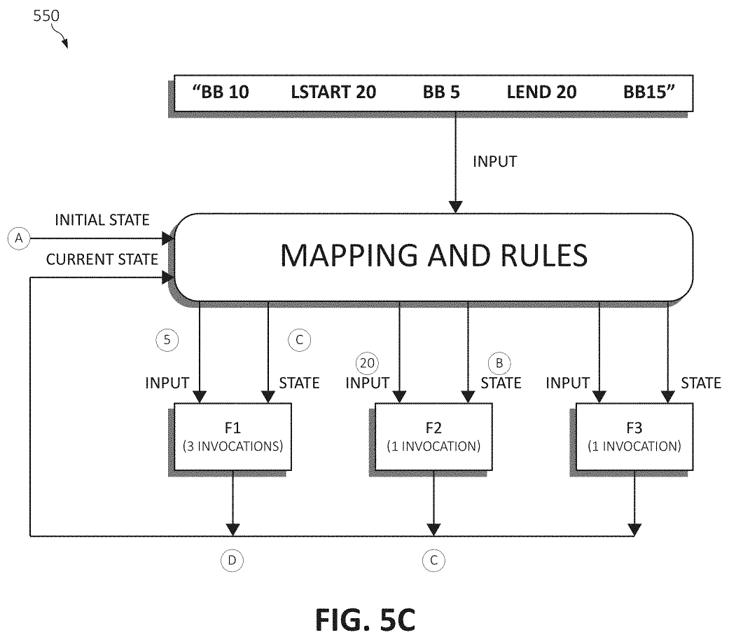

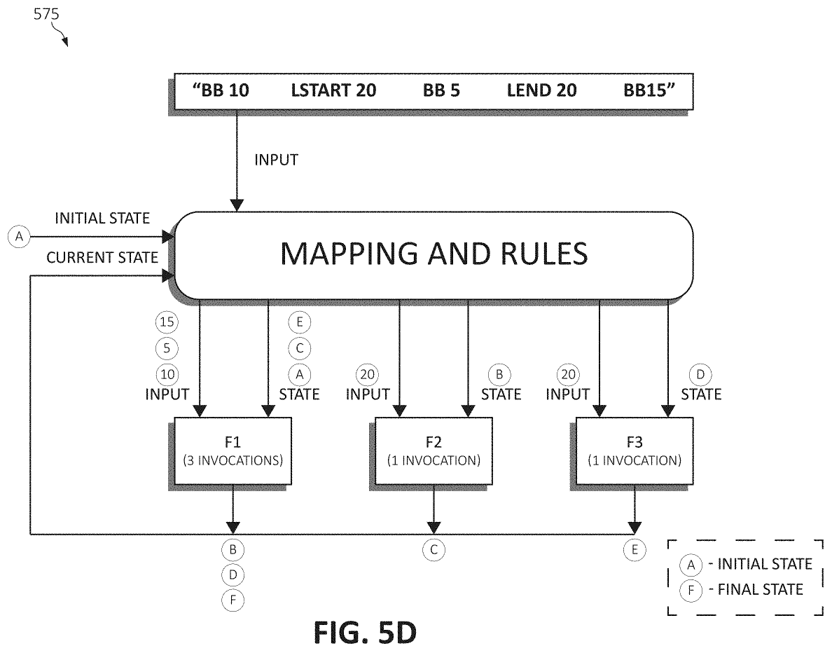

In view of the method 400 of FIG. 4, FIG. 5A-5D depict a structure of a machine learning model for an input data instance. That is, FIG. 5A-5D illustrate an input data instance progressively inputting the grammar entity format that are mapped to the grammar entity function.

As a preliminary matter, the example described in FIG. 4 may be used in FIG.'S 5A-5D by way of example only. Accordingly, an example input string (e.g., grammar entity format) may be: “BB 10 LSTART 20 BB 5 LEND 20 BB 15” for construction of a machine learning model for structured inputs. Moreover, the initial state may be illustrated as initial state (“A”) and final state may be illustrated as final state (“F”).

As illustrated in FIG.'S 5A-5D, mappings and rules may be used to provide one or more inputs into one or more functions such as, for example, function (“F1”), function (“F2”), and/or function (“F3”). That is, function F1-F3 may be component models of an overall machine learning model. The input data string of “BB 10 LSTART 20 BB 5 LEND 20 BB 15” may be input into the mappings and rules. The functions receive 2 inputs and the output of each function are feed back into the mapping and rules.

In one aspect, a function or parameter of function F1, F2, and F3 may be learned. In one aspect, by way of example only, the grammar entity format may be a simple sequence and the mappings and rules may indicate that the output of a preceding function may be the input state vector of succeeding function. The connection between the functions may be specified according to where the inputs are coming from and where the outputs are going towards.

As illustrated in FIG. 5A, the initial input state (A) may be a state vector and a current state and a property value may come from an input data string (e.g., “BB 10 LSTART 20 BB 5 LEND 20 BB 15”). The output is an output state vector. When, for example, the input data string is formatted as a simple sequence (e.g., “BB 10 LSTART 20 BB 5 LEND 20 BB 15”), for every next token that comes in, the output of the previous token (which is an output state vector) becomes the current state vector.

In one aspect, for each grammar entity structure (e.g., basic block (BB), LSTART, and LEND) there may be a corresponding function (e.g., F1 for BB, F2 for LSTART, and F3 for LEND. Thus, for the initial BB 10, the initial input state (A) may be the state vector. From the mapping and rules, the current state (A) and the annotated property value (10) that comes from the input data string (for BB 10 or token 10) may be input into the F1. The output of F1 may be the current state (B). That is, the current state (B) is now input into the next function F2. As illustrated in FIG. 5B, the input data string (for LSTART) may be input into the F2. The current state is now current state (B) and the annotated property value input (20), which comes from the input data string (for LSTART 20) may be input into the F2. The output of F2 is now current state (C).

Turning now to FIG. 5C, from the mapping and rules for the BB 5, the input state is now the current state (C) and the annotated property value (5) that comes from the input data string (for BB 5) may be input into the F1 (e.g., grammar entity BB 5 is mapped to function F1). The output of F1 is now current state (D), which is fed back into the mapping and rules. That is, the current state (D) is now input into the next function F3.

In FIG. 5D, a final display is illustrated that also includes applying the mapping and rules for grammar entity LEND 20 and BB 15. For the grammar entity LEND 20, the current state (D) is input into F3 and the annotated property value (20) may come from the input data string (for LEND 20) and may be input into the F3. The output of F3 is now the current state (E). Also, the input state is now the current state (E) and the annotated property value (15) that comes from the input data string (for BB 15) may be input into the F1 (e.g., grammar entity BB 15 is mapped to function F1). The output of F1 is now current state (F), which is fed back into the mapping and rules.

For training and using the constructed machine learning, there may be two passes: 1) a forward propagation and 2) a backward propagation. The forward propagation may be applied as described in FIG.'S 5A-5D. For the backward propagation, the deltas are computed and propagated in reverse through the individual components that compose the overall machine learning model. For those function components of the machine learning that are to be learned, the function components are to be differentiable components (e.g., individual components). For functions known apriori, either an inverse function must exist, and/or a reverse relationship may be statically defined for all points in the data domain. The overall function being learned may be trainable. For those functions that are not learned or are known, an inverse function may be used, and/or a reverse relationship is to be determined for use in the backward propagation. It should be noted that depending on the specific input data, only a subset of machine learning model components will be exercised for an inference instance.

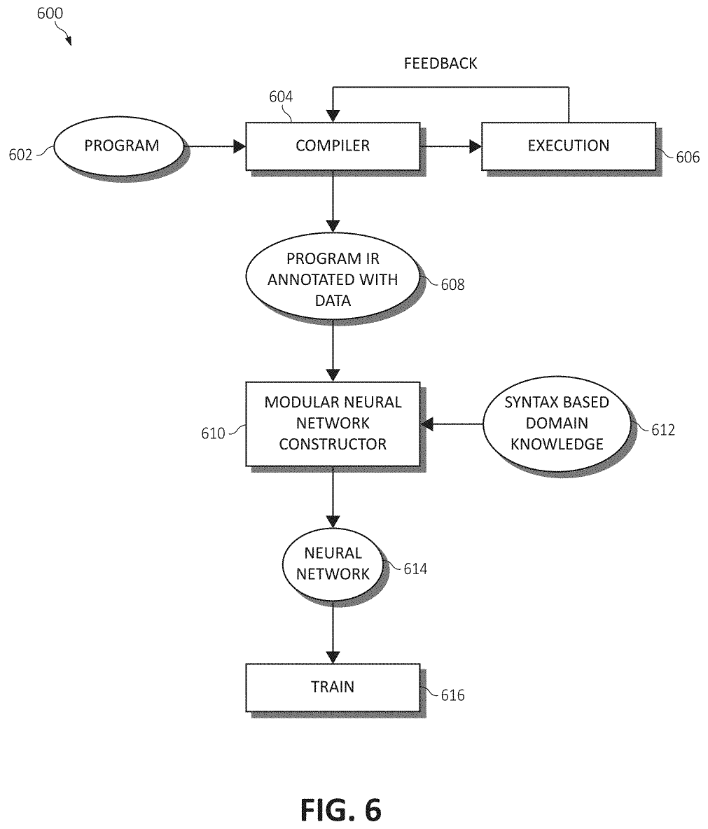

FIG. 6 is an additional flowchart diagram 600 depicting an additional exemplary method for construction of a machine learning model for structured inputs, again in which various aspects of the present invention may be realized. That is, the flowchart diagram 600 illustrates an example for preprocessing of data for construction of a machine learning model for structured inputs such as, for example, estimating dynamic instruction counts for computer programs such as described in FIG.'S 5A-5D. The functionality 600 may be implemented as a method executed as instructions on a machine, where the instructions are included on at least one computer readable medium or one non-transitory machine-readable storage medium.

The functionality 600 may start with a computer program 602 being feed into a compiler, as in block 604. The compiler may compile and execute the computer program 602 and provide feedback data, as in block 606. The execution enables a profile to be generated to assist in annotating the grammar entities with property data (e.g. profile information). At block 608, a computer program may be annotated with profile information, as in block 608. Syntax based domain knowledge (e.g., grammar entities such as, the grammar input entities described in FIG.'S 5A-5D of “BB, LSTART, LEND, BB”) may be provided from block 612. The syntax-based domain knowledge from block 612 and the computer program annotated with data from blocks 608 may be input into a modular neural network constructer, as in block 610, and output a constructed machine learning model (e.g., a neural network), as in block 614. The neural network may be trained (as described herein), as in block 616. The functionality 600 may end at block 616.

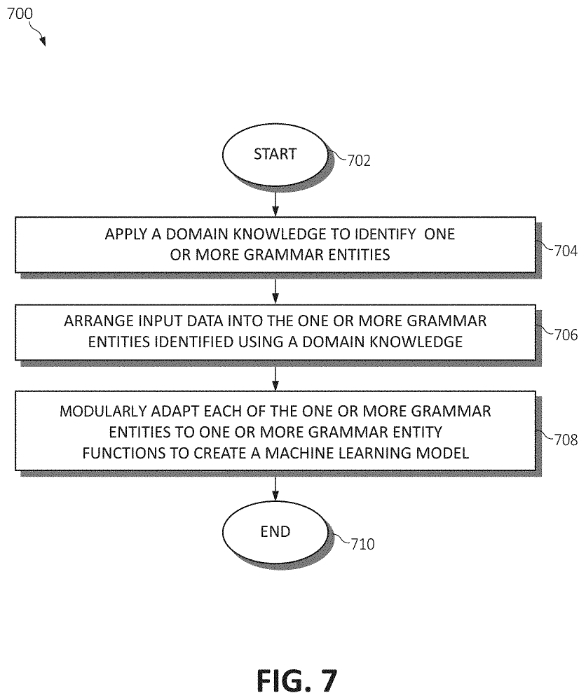

FIG. 7 is an additional flowchart diagram 700 depicting an additional exemplary method for construction of a machine learning model for structured inputs, again in which various aspects of the present invention may be realized. The functionality 700 may be implemented as a method executed as instructions on a machine, where the instructions are included on at least one computer readable medium or one non-transitory machine-readable storage medium. The functionality 700 may start in block 702.

A domain knowledge may be applied to identify one or more grammar entities (e.g., semantic entities identified using natural language processing “NL”), as in block 704. The one or more grammar entities may be tokens, semantic expressions, subsets of tokens and semantic expressions, or a combination thereof. Input data may be arranged into the one or more grammar entities identified using the domain knowledge, as in block 706. Each of the one or more grammar entities may be modularly adapted to one or more grammar entity functions to create a machine learning model, as in block 708. The functionality 700 may end, as in block 710.

In one aspect, in conjunction with and/or as part of at least one block of FIG. 7, the operations of method 700 may include each of the following. The operations of method 700 may annotate the one or more grammar entities with selected property data. Input data may be formatted into a selected arrangement of the one or more grammar entities. The one or more grammar entities may be mapped to the one or more grammar entity functions.

The operations of method 700 may use a current state vector and an annotated property input value as inputs for each of the one or more grammar entity functions, and/or generate a next state vector as output from the one or more grammar entity functions. The operations of method 700 may use one or more rules to create each of the one or more grammar entity functions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for construction of a machine learning model for structured inputs by a processor, comprising:
arranging input data into one or more grammar entities identified using a domain knowledge; and
modularly adapting each of the one or more grammar entities to one or more grammar entity functions to create a machine learning model.

2. The method of claim 1, further including applying the domain knowledge to identify the one or more grammar entities, wherein the one or more grammar entities are tokens, semantic expressions, subsets of tokens and semantic expressions, or a combination thereof

3. The method of claim 1, further including annotating the one or more grammar entities with selected property data.

4. The method of claim 1, wherein arranging input data into one or more grammar entities further includes formatting the input data into a selected arrangement of the one or more grammar entities.

5. The method of claim 1, further including statically mapping the one or more grammar entities to the one or more grammar entity functions.

6. The method of claim 1, further including:
using a current state vector and an annotated property data as inputs for each of the one or more grammar entity functions; and
generating a next state vector as output from the one or more grammar entity functions.

7. The method of claim 1, further including using one or more rules to create each of the one or more grammar entity functions.

8. A system for construction of a machine learning model for structured inputs, comprising:
one or more computers with executable instructions that when executed cause the system to:
arrange input data into one or more grammar entities identified using a domain knowledge; and
modularly adapt each of the one or more grammar entities to one or more grammar entity functions to create a machine learning model.

9. The system of claim 8, wherein the executable instructions further apply a domain knowledge to identify the one or more grammar entities, wherein the one or more grammar entities are tokens, semantic expressions, subsets of tokens and semantic expressions, or a combination thereof.

10. The system of claim 8, wherein the executable instructions further annotate the one or more grammar entities with selected property data.

11. The system of claim 8, wherein the executable instructions for arranging input data into one or more grammar entities further format the input data into a selected arrangement of the one or more grammar entities.

12. The system of claim 8, wherein the executable instructions further statically map the one or more grammar entities to the one or more grammar entity functions.

13. The system of claim 8, wherein the executable instructions further:
use a current state vector and an annotated property input value as inputs for each of the one or more grammar entity functions; and
generate a next state vector as output from the one or more grammar entity functions.

14. The system of claim 8, wherein the executable instructions further use one or more rules to create each of the one or more grammar entity functions.

15. A computer program product for automated extraction and summarization of decision discussions of a communication by a processor, the computer program product comprising a non-transitory computer-readable storage medium having computer-readable program code portions stored therein, the computer-readable program code portions comprising:
an executable portion that arranges input data into one or more grammar entities identified using a knowledge domain; and
an executable portion that modularly adapts each of the one or more grammar entities to one or more grammar entity functions to create a machine learning model.

16. The computer program product of claim 15, further including an executable portion that applies a domain knowledge to identify the one or more grammar entities, wherein the one or more grammar entities are tokens, semantic expressions, subsets of tokens and semantic expressions, or a combination thereof.

17. The computer program product of claim 15, further including an executable portion that annotates the one or more grammar entities with selected property data.

18. The computer program product of claim 15, further including an executable portion that:
formats the input data into a selected arrangement of the one or more grammar entities; and
statically maps the one or more grammar entities to the one or more grammar entity functions.

19. The computer program product of claim 15, further including an executable portion that:
uses a current state vector and an annotated property input value as inputs for each of the one or more grammar entity functions; and
generates a next state vector as output from the one or more grammar entity functions.

20. The computer program product of claim 15, further including an executable portion that uses one or more rules to create each of the one or more grammar entity functions.
